(19) United States
(12) Patent Application Publication
(10) Pub. No.: US 2022/0076302 A1
(43) Pub. Date: Mar. 10, 2022

(54) Product and Service Marketing System that Utilizes Localized Social Networking Platform

(71) Applicant: Light Miracle Workers LLC, Yardley, PA (US)

(72) Inventors: Eric Markowitz, Yardley, PA (US); Alicia Markowitz, Yardley, PA (US); Marianne Pastore, Pittstown, NJ (US)

(73) Assignee: Light Miracle Workers LLC

(21) Appl. No.: 17/013,531

(22) Filed: Sep. 4, 2020

(51) Int. Cl. G06Q 30/02; G06Q 50/00

(52) U.S. Cl. CPC G06Q 30/0282; G06Q 50/01

(57) ABSTRACT

A system and method for selecting and evaluating a merchant utilizing a social networking platform. Servers host a private social networking platform. The social networking platform can be accessed by consumers and merchants who have joined as members. Each member merchant has a merchant computer that is used to upload a listing for the member merchants. The listing includes reviews provided by the member consumers that produce average review ratings for the member merchants. Each member consumer has a consumer computer that enables the member consumers generate reviews for the member merchants and post comments regarding the member merchants on the private social networking platform. An administrator analyzes the review ratings of the member merchants. If a member merchant receives a review rating that falls below a threshold value, the administrator can deny access to the social networking platform to the underperforming member merchant.

### BACKGROUND OF THE INVENTION

### 1. Field of the Invention

In general, the present invention relates to systems and methods used to connect network member merchants with network member consumers. More particularly, the present invention relates to systems and methods to search, select, and review merchants using a closed social networking platform.

### 2. Prior Art Description

Similar products are often sold by many different merchants. Likewise, many merchant service providers provide the same services. It is often very difficult for a consumer to select one merchant over another. Likewise, it is equally difficult for a quality merchant to distinguish his/her products and services over the products and services of another. Consumers tend to rely heavily upon recommendations they receive from other consumers they may know. If no recommendations are available, merchants for products and services are often researched on the Internet® or through a social network such as Facebook®, Craigslist® or the like.

A problem with randomly searching for a product or service merchant on-line is that some merchants pay search engines to be listed high in the search results. These merchants get more “clicks” than merchants lower in the results list. However, the merchants that pay to be listed first are not always the best or the least expensive available. Furthermore, when shopping on-line, a consumer often finds that a product or service merchants is rated. This is typically done with rating stars on a scale of one star to five stars. The problem with relying upon on-line reviews is that reviews are often self-generated by the merchant or otherwise manipulated by the merchant. Bad reviews can be buried by a multitude of false good reviews. There are many companies that can be hired by a merchant whose job it is to produce false good reviews. Another problem with on-line reviews is the lack of reviews. Often no reviews are posted for many of the merchant's products and services. Since on-line rates can be manipulated, many consumers consider on-line ratings to be unreliable.

Recognizing that on-line reviews may be lacking or manipulated, systems have been developed to help on-line consumers find the appropriate merchant and vice versa. Many people who shop on-line also conduct other activities on-line. Many belong to various social networking platforms. In these social networking platforms, people exchange information and often receive information, either true or false, about various product and/or service merchants.

In U.S. Patent Application Publication No. 2011/0047013 to McKenzie, a system is disclosed where a person can post comments about a product or service on-line in a social network. Other members of the social network can then post comments about the goods or services and can even vote on what product or service should be used. As such, a consumer depends upon the opinions of the collective majority of participants to make a decision. The number of people in a social network who participate in such polling may be very small. As such, results can be skewed by only a few votes. Again, these few votes can be controlled by various merchants and/or paid marketing agents working for merchants.

In many on-line social networks, people have the ability to “like” a post or otherwise indicate approval or disapproval of another's posting. In U.S. Pat. No. 9,633,398 to Jesudian, a system is shown where a “like” indication for a product or service can be automatically converted into a link for purchasing that product or service. This too has disadvantages. In this system, a purchase decision is based upon one person's opinion in an on-line posting. Such a system can easily be manipulated by postings made by merchants and/or by marketing agents working for merchants.

In modern society, there are people who earn a living using social media platforms. These people post content that attract thousands, sometimes millions of followers. The more followers a person has, the more influential that person is considered. Such influential social network users then get paid by merchants to use or recommend certain products or services in their posts. In U.S. Patent Application Publication No. 2013/0304582 to Beazley, a system is shown that enables influential social network users to connect with merchants and to get paid by recommending the products and services of the merchants. Since this system is pay-to-play, the social posting is little more than a paid advertisement.

A need therefore exists in the art, for a way to recommend products and services within a social network platform, that cannot be unfairly manipulated by merchants or marketing agents. In this manner, consumers can trust that posts and reviews are authentic and can make purchasing decisions accordingly. This need is met by the present invention as described and claimed below.

### SUMMARY OF THE INVENTION

The present invention is a system and method for selecting and evaluating a merchant utilizing a private social networking platform.

At least one server is used that is maintained by a system administrator. The servers are accessible through a data network, wherein the servers host a private social networking platform. The private social networking platform can only be accessed by consumers and merchants who have joined as members of the private social networking platform.

The system utilizes a searchable database that is maintained through the servers, wherein the database can be accessed by merchant computers and consumer computers. Each member merchant has a merchant computer that communicates with the server through the data network. Each merchant computer is used to upload a listing for the member merchants. The listing includes reviews provided by the member consumers that produce average review ratings for the member merchants.

Each member consumer has a consumer computer that communicates with the server through the data network. The consumer computer enables the member consumers to search the database, generate reviews for the member merchants, and post comments regarding the member merchants on the private social networking platform. The reviews and comments are saved to the searchable database.

The private social networking system has a system administrator. The system administrator automatically analyzes the review ratings of the member merchants using customizable filtering algorithms. If a member merchant receives a review rating that falls below a threshold value, the system administrator can deny access to the private social networking platform by the underperforming member merchant. As a result, only well-performing member merchants remain in the private social networking system which better serves the needs of the member consumers.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the hardware requirements of the present invention system;

FIG. 2 is a schematic showing the operational features of the present invention system; and

FIG. 3 is a block diagram showing the operational logic for an exemplary embodiment of the present invention system.

### DETAILED DESCRIPTION OF THE DRAWINGS

Although the present invention system and method can be used to connect consumers with many types of product or service merchants, the present invention system and method is especially useful in selecting product and service merchants in the personal wellness industry. That is, merchants such as yoga instructors, personal trainers, chiropractors, therapists and the like whose skill sets vary widely from merchant to merchant and whose businesses rely heavily upon word of mouth recommendations. Accordingly, the exemplary embodiment being described below references personal wellness services in order to set forth one of the best modes contemplated for the invention. The embodiment, however, is merely exemplary and should not be considered a limitation when interpreting the scope of the appended claims.

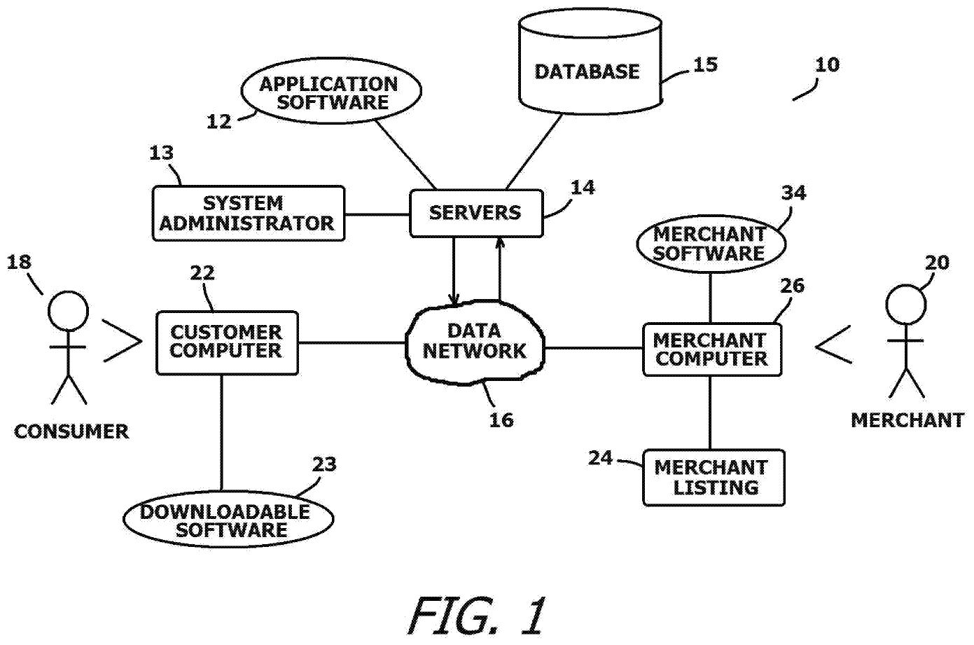

The purpose of the present invention system is to provide a consumer with the ability to find a merchant by providing access to unbiased reference sources that provide information about the merchant. The same system can enable a merchant, once selected by a consumer, with the ability to view information about the consumer in order to provide better consumer service. Referring to FIG. 1, the hardware requirements of the present invention marketing system 10 are shown. The marketing system 10 utilizes application software 12 that is run, in part, by one or more computer servers 14 that are maintained by a system administrator 13. The system administrator can be any person or group of persons who run software to monitor, maintain and update the marketing system 10 and its application software 12. The computer servers 14 also maintain one or more content databases 15. The content databases 15 are searchable using Boolean search parameters, as is later explained. The computer servers 14 are accessible through a data network 16, such as a cellular network and/or the Worldwide Web.

The marketing system 10 is accessed both by participating consumers 18 and by participating merchants 20. Each consumer 18 accesses the marketing system 10 using a computing device 22, such as a desktop computer, a laptop computer, or a smart phone. The consumer 18 can access a website that is running the application software 12 of the server 14. Otherwise, the consumer 18 can utilize downloadable software 23 that works in unison with the application software 12 being run by the server 14.

The participating merchants 20 also interact with the marketing system 10 using their own computers. Each merchant 20 has a merchant computer 26 through which the merchant 20 creates and maintains a merchant listing 24.

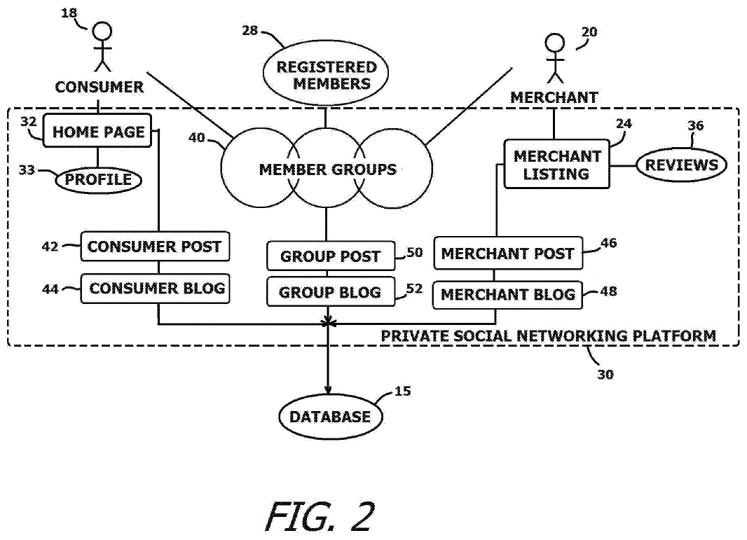

Referring to FIG. 2 in conjunction with FIG. 1, it can be seen that the marketing system 10 uses a private social networking platform 30 that can only be accessed by registered members 28. There are two types of registered members 28. These include the consumers 18, who are using the marketing system 10 to locate a reputable merchant for a product or service. Likewise, the registered members also include merchants 20, who are looking to sell their products or services to consumers. For consumers 18 to become registered members 28, the consumer 18 adds the downloadable software 23 into their computing device 22 that can interact with the application software 12 being run by the computer servers 14. The consumer 18 are required to enter limited information, such as name, wherein the consumer 18 is provided with a personalized homepage 32. The consumer 18 is encouraged to prepare a profile 33 on the personalized homepage 32, the purpose of which is later explained.

For a merchant 20 to become registered member 28, the merchant 20 downloads merchant software 34 into their computers 26 or smart phones that can interact with the application software 12 being run by the server 14. The merchant 20 creates a listing 24 and/or provides a link to an existing listing where the products and/or services offered by the merchant 20 can be purchased. The listing 24 must also provide details about the merchant 20, including the location of the merchant 20, and the goods and/or services of the merchant 20. The listing 24 of the merchant 20 contains a review section, where reviews 36 from member consumers 19 are posted. As will be later explained, only member consumers 18 who have purchased a product from the merchant 20 or who have used the services of the merchant 20 will be qualified to post an addition to the reviews 36.

Once a consumer 18 or merchant 20 joins the private social networking platform 30, both the consumer 18 and the merchant 20 are free to create or join member groups 40. A member group 40 typically has a shared interest, such as photography or pain management. Consumers 18 may join a group, such as a pain management group, because they are looking for information or support regarding pain management. A merchant 20 may join such a member group 30 if the merchant 20 has products and/or services that relate to pain management. Accordingly, within the private social networking platform 30, there are three primary entities capable of providing content. These entities are individual consumers 18, individual merchants 20, and member groups 40.

Member consumers 18 can create consumer posts 42 and/or maintain consumer blogs 44. Likewise, member merchants 20 can create merchant posts 46 and maintain merchant blogs 48. Various member groups 40 can also create group posts 50 and/or maintain group blogs 52. All posts and blogs are stored in the searchable database 15. The system administrator 13, using human supervision, or specialized software that contains phraseology algorithms and/or content crawler programs, digitally mine the posts for searchable material.

Each consumer 18 has a personalized homepage 32 that they access when they log onto the private social networking platform 30. On each personalized homepage 32, the consumer 18 is provided a Boolean search field to search one or more terms. The search is limited to the content of the private social networking platform 30 maintained in the administration database 15. The search may show relevant merchant listings or various posts or blogs that discuss relevant merchants 20. Using the search results, the member consumer 18 can read relevant consumer posts 42, consumer blogs 44, group posts 50, group blogs 52, merchant posts 46, and merchant blogs 48. From this information, the member consumer 18 may visit the listing 24 of one or more merchants 20. At the merchant listing 24, the member consumer 18 can read the reviews 36. The reviews 36 may link to various postings and blogs that may further educate the member consumer 18 on the merits and deficits of various merchants 20.

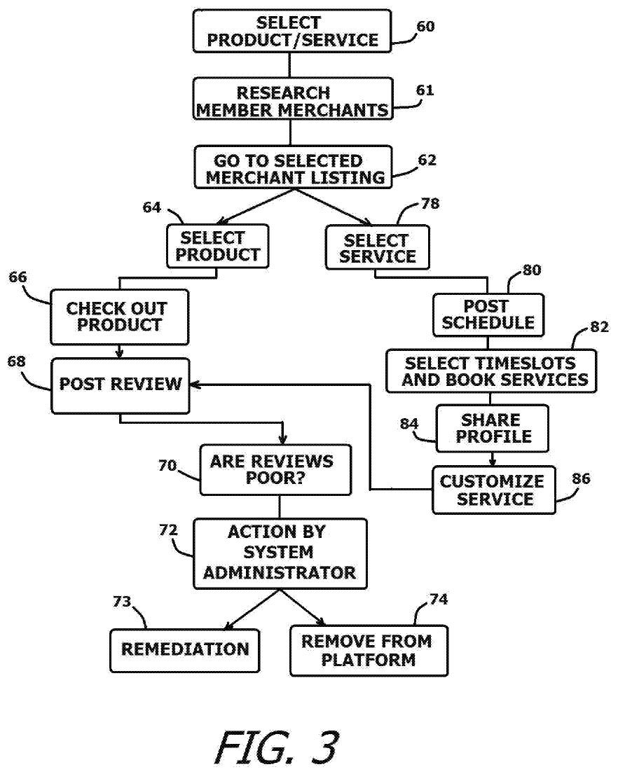

Referring to FIG. 3 in conjunction with FIG. 2 and FIG. 1, it can be seen that once a member consumer 18 researches and selects a merchant 30 for the purpose of purchasing a product or service, the member consumer 18 connects to the listing 24 of the merchant 30 within the private social networking platform 30. See Block 60, Block 61, and Block 62. Once at the merchant listing 24, if the member consumer 18 is buying a product, then the member consumer 18 selects the product and places it in a virtual basket for checkout. See Block 64 and Block 66. Once the member consumer 18 has checked out, the member consumer 18 is granted the authority, through the private social network platform 30, to create a review 36. See Block 68. This authorized review 36 is posted to the listing 24 of the merchant 20 and cannot be altered or deleted by the merchant 20.

The reviews 36 posted for any of the member merchants 20 can be averaged to obtain an average review rating. If the merchant 20 receives an average review rating that is below a threshold value, such as 2.5 stars, then the system administrator 13 can take action. See Block 70 and Block 72. The actions taken by the system administrator can include preprogrammed actions that are automatically triggered or custom actions for unusual circumstances. The system administrator 13 can require the merchant 20 to satisfy the member consumers 18 or otherwise take corrective actions. If the merchant 20 fails to correct, the membership of the merchant to the private social networking platform 30 can be revoked. The merchant's listing 24 will be removed and searchable citations that reference the merchant 20 can be suppressed in search results. See Block 73 and Block 74.

If the member merchant 20 provides a service, the private social networking platform 30 can provide specialized features. See Block 78. Services, especially in the personal wellness industry, tend to be multiple-event services. That is, the service requires more than one interaction between the consumer 18 and the merchant 20 within a period of time. For example, a yoga instructor or exercise instructor may offer continuous sessions for as long as a consumer desires. Chiropractors and therapists may offer sessions for a prolonged, but fixed, period of time. Instructional courses have a first class and a last class. In many such services, the services must be provided live. With some services, such as instructional classes, live coaching can be offered but also, the services can be offered as recorded services. At the merchant listing 24, the merchant 20 can post a schedule of available timeslots for live sessions or live on-line sessions. See Block 80. The consumer 18 can then select from the posted time slots and book the service. See Block 82.

If a consumer 18 selects to purchase a service, the consumer 18 has the option of sharing their profile 33 with the merchant 20 through the private social networking platform 30. In this manner, the merchant 20 receives information about the consumer 18, such as age, that may be useful in customizing the services being rendered. See Block 84 and Block 86.

At the end of any service session, either in-person or on-line, the member consumer 18 has the ability to review the member merchant 20. If the merchant 20 receives enough poor reviews 36 from member consumers 18, then the system administrator 13 can take action. See Block 70 and Block 72. The system administrator 13 can require the merchant 20 to satisfy the member consumers 18 or otherwise perform remediation. If the merchant 20 fails to correct, the membership of the merchant 20 to the private social networking platform 30 can be revoked. The merchant listing 24 will be removed and searchable citations that reference the merchant 20 can be suppressed in search results. See Block 74.

Merchants 20 pay to be members of the private social networking platform 30. The consumers 18 are offered memberships for free or little cost. The incentive to the consumers 18 is that only quality merchants 20 with good reviews are members of the private social networking platform 30. Furthermore, the reviews 36 provided on the private social networking platform 30 are unbiased, reliable, and easily accessed. In addition, merchants 20 are easily searched as are the goods and services provided by the merchants 20.

The incentive to the merchants 20 to join the private social networking platform 30 is self-evident. The private social networking platform 30 acts as a referral service, wherein the merchants 20 can showcase goods and services to a pool of active consumers.

It will be understood that the embodiment of the present invention that is illustrated and described is merely exemplary and that a person skilled in the art can make many variations to that embodiment. All such embodiments are intended to be included within the scope of the present invention as defined by the appended claims.

What is claimed is:

1. A system for selecting and evaluating a merchant, comprising:
at least one server, maintained by a system administrator, that is accessible through a data network, wherein said at least one server hosts a private social networking platform that can only be accessed by member consumers and member merchants;
a searchable database maintained through said at least one server;
a merchant computer for each of said member merchants that communicates with said at least one server through said data network, wherein each said merchant computer is used to upload a listing for a different one of said member merchants, wherein said listing includes reviews provided by said member consumers that produce average review ratings for said member merchants;
a consumer computer for each of said member consumers that communicates with said at least one server through said data network and enables said member consumers to search said database, generate said reviews for said member merchants, and post comments regarding said member merchants on said private social networking platform, wherein said reviews and said comments are saved to said searchable database;
wherein said system administrator analyzes said review ratings and denies access to said private social networking platform of any of said member merchant that have a review rating below a predetermined threshold value.

2. The system according to claim 1, wherein said member merchants post comments on said private social networking platform that are saved in said database.

3. The system according to claim 1, wherein said reviews for said member merchants are limited to said member consumers that have completed purchases from said member merchants.

4. A system for selecting and evaluating a merchant, comprising:
at least one server maintained by a system administrator that is accessible through a data network, wherein said at least one server hosts a social networking platform that can only be accessed by member consumers and member merchants;
merchant computers for said member merchants that communicate with said at least one server through said data network, wherein said merchant computers are used to upload listings for said member merchants that can be viewed in said social networking platform, wherein said listings include reviews provided by said member consumers that produce an average review rating for each of said member merchants;
consumer computers for said member consumers that communicate with said at least one server through said data network and enable said member consumers to post said reviews about said member merchants,
wherein said system administrator analyzes each said review rating and denies access to said social networking platform of any of said member merchants where said review rating is below a predetermined threshold value.

5. The system according to claim 4, further including a searchable database, wherein said member consumers post comments regarding said member merchants on said social networking platform that are saved to, and searchable within, said searchable database.

6. The system according to claim 4, wherein said reviews for said member merchants are limited to being received from said member consumers that have completed purchases from said member merchants.

7. A method for selecting and evaluating a merchant, comprising:
providing at least one server maintained by a system administrator that hosts a social networking platform, wherein said social networking platform can only be accessed by member consumers and member merchants;
having said member merchants provide listings on said social networking platform through which said member consumers can purchase goods and services from said member merchants;
posting reviews for said member merchants on said social networking platform, wherein said reviews are made by said member consumers for said goods and services purchased from said listings, wherein said reviews posted by said member consumers produce an average review rating for each of said member merchants;
removing any of said member merchants from said social networking platform where said review rating is below a predetermined threshold value.

8. The method according to claim 7, further including posting comments about said member merchants on said social networking platform, wherein said comments are saved in a searchable database.
